(19) United States
(12) Patent Application Publication
(10) Pub. No.: US 2003/0098909 A1
(43) Pub. Date: May 29, 2003

(54) Process for monitoring the internal space of a vehicle, as well as a vehicle with at least one camera within the vehicle cabin

(76) Inventors: Martin Fritzsche, Biberach (DE); Otto Lohlein, Illerkirchberg (DE); Fridtjof Stein, Ostfildern (DE); Alexander Wurz-Wessel, Salach (DE)

Correspondence Address: Stephan A. Pendorf, Pendorf & Cutliff, P.O. Box 20445, Tampa, FL, 33622-0445, US

(21) Appl. No.: 10/307,171

(22) Filed: Nov. 29, 2002

(30) Foreign Application Priority Data
Nov. 29, 2001 (DE) 101 58 415.6-21

(51) Int. Cl. H04N 7/18

(52) U.S. Cl. 348/148

(57) ABSTRACT

The invention concerns a device for the optical monitoring of the internal space of a vehicle, wherein the vehicle internal space is monitored by at least one panorama camera (2; 4), of which images are supplied in curvilinear coordinates, wherein the images obtained from the panorama camera (2; 4) are transformed to cylindrical or planar coordinates (6) and wherein the transformed images are subjected to an electronic image evaluation (8). The invention makes it possible with one single camera to carry out various monitoring functions both in the internal spaces as well as the external space of the vehicle.

### BACKGROUND OF THE INVENTION

1. Field of the Invention

The invention concerns a process for the optical monitoring of the internal space of a vehicle as well as a vehicle with at least one camera in the vehicle cabin.

2. Description of the Related Art

Motor vehicles with a camera within the vehicle cabin are known. For example, one could use individual cameras with a field of view directed through the windows of the vehicle towards the outside for monitoring the area ahead of, to the side of or towards the rear. Cameras for observing parts of the vehicle internal space have already been proposed, see for example DE-A-198 03 158, which discloses a device for the optical monitoring of the state of alertness of the operator of the vehicle.

### SUMMARY OF THE INVENTION

The present invention is concerned with the task of providing a camera system for monitoring the internal space of a vehicle, which can be simultaneously utilized for multiple diverse monitoring functions and in addition can be used for further additional functions.

This task is inventively solved by a process according to claim 1 and a vehicle according to claim 10.

According to the invention the vehicle internal space is monitored using a panorama camera, which in the preferred embodiment of the invention is comprised of a conventional digital camera and a—for example ball shaped or parabolic convex—mirror which is in the view of the camera.

This type of panorama camera is described for example in PCT Publication No. WO-9930197, WO-9945422 and WO-9743854 and is employed for example for the purposes of monitoring and for robot navigation. They produce a 360° panoramic image similar to a fish-eye camera. In contrast to fish eye cameras, which at their observation horizon, that is, the edge of their azimuth observation range of maximally 180°, can not practically distinguish details, panoramic cameras provide also in their edge area of the image details and even make possible azimuth exposure of more than 180°.

With suitable arrangement of the panorama camera a very large part of the vehicle internal space can be monitored at once, for example when positioning the convex mirror inside the vehicle ceiling the entire there-under lying hemisphere can be observed. At the same time it is also conceivable to integrate the convex mirror into the dashboard, in particular when the forward area of the vehicle internal space is primarily to be monitored.

Since the obtained images are strongly contorted, that is, are presented in some type of curvilinear “world coordinates”, one or more non-contorted partial images are produced therefrom, in that the images from the camera are transformed onto cylindrical or planar coordinates. The relationship between the curved coordinate system of the camera image and the cylindrical or planar target coordinate system is determined by the mirror geometry and the arrangement of mirror and camera. During transformation the intensity and, in certain cases, color values of each image point of the camera image is assigned to a point in the cylindrical or planar coordinate system, of which the coordinates, for example in the case of spherical mirror, result from trigonometric relationships.

The appropriate calculations could in principle be carried out in real time in a computer onboard the vehicle; in order to reduce the amount of calculation required, the described transformation is in practice however preferably carried out on the basis of one or more transformation tables, which are carried out within the framework of a camera calibration and are stored in an onboard computer or hard wired image correction electronics for use during the operation of the camera.

In this manner one obtains one or more partial images of the vehicle internal space, with only a one-dimensional distortion (in the case of a transformation to a cylindrical coordinate) or, as the case may be (in the case of a transformation to a planar coordinate), no distortion at all remains, so that straight lines are reproduced as straight lines. Such images in cylindrical or planar coordinates can then be electronically further processed, in particular, they can be evaluated.

In the inventive process the transformed images are at least subjected to an image evaluation for recognition of objects in the vehicle internal space, wherein the objects to be recognized could be for example persons. This makes possible a simple determination of the number and respective seating position of vehicle occupants in the front and back seats. This information could be advantageously employed for the automatic adjustment of operating parameters of the vehicle. For example, the passenger airbag can be deactivated when the passenger seat is unoccupied, so that in the case of an accident the repair costs remain low. With conventional techniques such a seat occupation-recognition can only be realized with complex measures, since each seat must be equipped with an appropriate sensor.

Besides this, the invention makes it possible not only to recognize the presence of persons in the individual vehicle seats, but rather also to recognize their position or posture in the seat. A seat position recognition of persons in the vehicle in addition to a pure seat occupying recognition makes it possible for example to automatically activate or deactivate safety systems depending upon the situation. For example the passenger airbag can be automatically deactivated when the passenger places his feet upon the dashboard, or, depending upon additional parameters such as vehicle speed and distance from a preceding vehicle, which are detected by some type of driver assist system, a warning signal can be given or the slack can be taken out of seatbelts if someone takes an unsafe posture during the trip, such as taking a position of bending far forward.

The size of the vehicle occupants and/or objects in the vehicle can likewise be determined. If for example a small child is recognized in the passenger seat or in a child safety seat placed there, or a child seat in the backseat, then based upon this recognition the appropriate airbag can be automatically deactivated. Unused seatbelts can also be recognized.

As the camera, one can employ for example a CCD-camera. Relatively simple CCD-cameras already have a sufficient resolution, in order to recognized objects at least in the vicinity outside of the vehicle when the windshield is in their field of view. This makes possible the application of the invention as a parking aid system or for automatic obstacle recognition. For example the driver can be automatically warned when he encounters a road pattern for changing the direction of travel and at the same time with the aid of the invention it can be recognized that a bicyclist is adjacent the vehicle.

For simultaneous monitoring of the external space also in the direction of travel it is preferred when the camera is placed as far forward in the vehicle as possible for example close behind the windshield. This would be at an expense to the visibility of the vehicle occupants on the rear seat. Depending upon which monitoring task in the given case is of primary importance, the camera is differently positioned and incorporated. In certain cases multiple cameras could also be used, for example a camera which monitors the external space in the direction of travel as well as the occupants in the front seats of the vehicle and a further camera which monitors the sides and rear space as well as occupants of the rear seats.

The relatively low cost solution using for example CCD-cameras makes possible many further applications in the framework of operator assistance systems, for example an automatic recognition of the direction of view the operator for example in a system for monitoring the condition of alertness of the operator.

A further advantageous application of the invention is in the case of a vehicle accident, to automatically store and/or using a radio to transmit to a location for vehicle assistance one of the transformed images or information extracted from the image signal processing, in order to facilitate a so-called post-crash analysis for example for selective emergency aid. Included in the information extracted from the image signal processing is for example the number of occupants, their condition of health, a crash analysis, deformation regarding the vehicle, location of the accident and extent of the damage.

Further advantageous possibilities of application of the invention are comprised of for example a security system (a person occupying the parked vehicle and not having proper authentication is considered a car theif), for supporting an automatic climate control by recognition of the position or condition of the sun or by recognition whether vehicle occupants are lightly clothed or warmly clothed, as well as saving having to have a special camera for video telephoning, in that a suitable transformed image of the respective conference participants can be produced and transmitted.

In contrast to the conventional optical recognition systems for vehicles, which respectively require one single specially dedicated and oriented camera, the present invention makes possible the carrying out of a multiplicity of tasks with only one or only a limited number of cameras.

There are a large number of possibilities of application of the invention in motor land vehicles; however, the invention can also be of advantage for other types vehicles, for example for carrying out monitoring tasks in airplanes.

### BRIEF DESCRIPTION OF THE DRAWINGS

Further characteristics and advantages of the invention can be seen from the dependent claims and from the following description of the illustrative embodiments on the basis of the figures. Therein there is shown:

FIG. 1 a principle sketch of a device for optical monitoring of the internal space of a vehicle,

FIG. 2 a principle sketch of a vehicle internal space, as would be seen from the camera of FIG. 1,

FIG. 3 a corrected partial image of the driver side of the vehicle internal space, and

FIG. 4 shows an alternative arrangement of camera and mirrors.

### DETAILED DESCRIPTION OF THE INVENTION

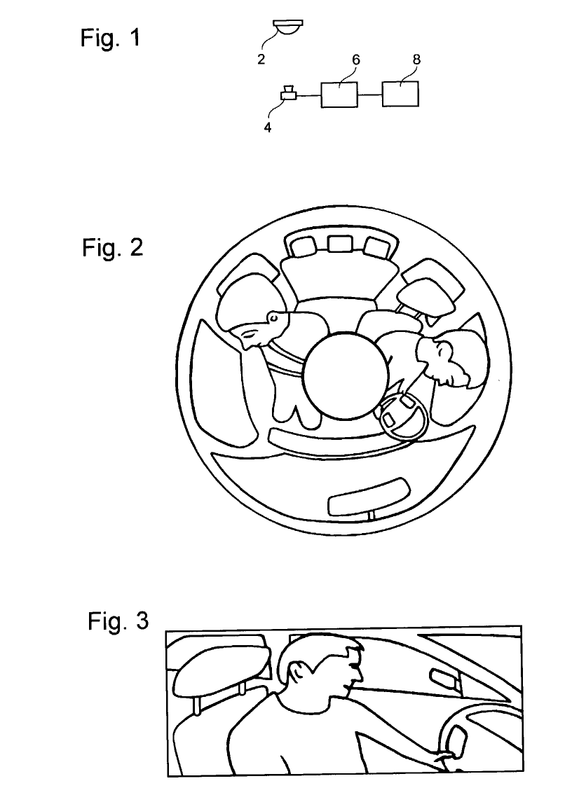

FIG. 1 shows a spherical or parabolic convex mirror 2 and a digital camera 4 directed towards the mirror 2, which together form a panoramic camera, as described for example in the above-mentioned references WO-9930197, WO-9945422 and WO-9743854. The convex mirror 2 is in this example provided between the front seats on the ceiling of a motor vehicle, wherein the mirror surface is directed downwards, and the camera 4 is provided with a certain amount of spacing perpendicularly thereunder, wherein it is either likewise mounted to the ceiling or is incorporated into a central console between the front seats.

In this arrangement the camera 4 sees in the convex mirror 2 an image of the hemisphere below the vehicle ceiling, as schematically represented in FIG. 2, with the exception of a mechanically or electronically blanked-out central area, in which the camera would be image itself. As one can see, the camera detects not only all seats and all vehicle occupants (in this example—two), but rather can see also through the vehicle windows towards outside, wherein various details of the external environment are not shown in FIG. 2.

The images provided at regular intervals by camera 4 are strongly contorted, since the environment is imaged according to the shape of the mirror 2 in spherical or some other curvilinear coordinate system. This image of the camera 4 is subjected to a correction device 6, in which one or more parts of the image are transformed to planar coordinates. For the driver's side one obtains an image, as represented in FIG. 3. This means, one obtains an undistorted image, wherein straight lines are again reproduced as straight lines.

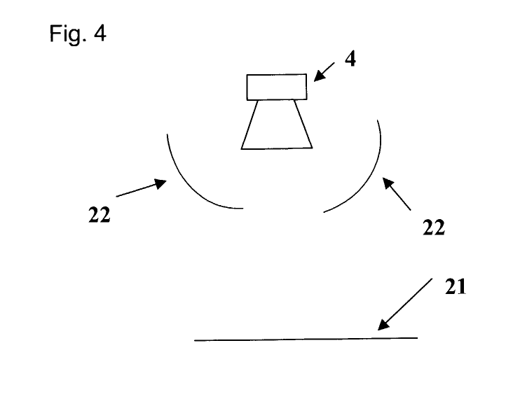

In FIG. 4 an alternative arrangement of camera 4 and mirrors 21 and 22 are shown. Such an arrangement makes it possible to integrate the camera in the vehicle ceiling, in the field of view of which the mirror 21 is located. If the camera 4 is surrounded by one or more concave mirrors 22 then in this manner approximately the same area can be monitored by camera 4 as can be observed by means of the arrangement illustrated in FIG. 1. Preferably in this arrangement the mirror 21 is likewise concave.

The transformation in the correcting device 6 is carried out for example in that light intensity and in certain cases color values of each image point of a camera image are associated with a point in a planar coordinate system, of which the coordinates are produced for example by trigonometric relationships, as can be calculated from the mirror geometry and from the positioning of mirror and camera. For simplification of the calculation of the necessary transformation relationships of the correction device 6 a spherical or parabolic mirror 2 is preferred, however in principle also any other type of convex mirror 2 can be employed.

In order to be able to rapidly carry out the transformation in a continuous operation in simple manner, one or more transformation tables are produced and stored during the installing of the panoramic camera, on the basis of which the correcting device 6 carries out the sequence of the transformations.

This can occur for example thereby, that one establishes empirically a two-dimensional transformation function with multiple variable parameters, which most closely approximates the image characteristics of mirror 2 and camera 4, then introduces in the vehicle internal spaces multiple straight calibration measuring rods (for example the introduction or application of a checkerboard pattern in the field of view of the camera) and with the aid of the calibration pattern so tweaks or adjusts the parameters, that the image of the calibration pattern provided by the correction device 6 is as straight as possible and in the correct proportion and angles. Image errors and errors of linearity on the basis of in precise orientation of camera 4 and mirror 2 are corrected for during the calibration by centering the blanked out or omitted area (central area in FIG. 2). On the basis of the thus obtained transformation function the transformation tables are then produced, which carry out the desired transformations.

The transformed image supplied by the correction device 6 is supplied to a device 8 for seat occupancy recognition, wherein it is subjected to respectively one electronic image evaluation for recognition of persons in the individual seats in the vehicle internal space, for example, on the basis of the outlines present in the images.

In addition or alternatively the transformed images can be further developed or be supplied to different types of monitoring or driver assistant systems, for example a device for recognition of the size and posture of persons on the individual seats, a device for recognition of seatbelt condition, a device for recognition of the direction of gaze, an image recorder and/or transmitter, a vehicle security device, a climate control system and/or a video telephone system.

Transformed partial images, which correspond respectively with the spaces visible through the windows of the front, side and rear spaces around the vehicle, are supplied to systems such as for example a system for monitoring the space ahead of the vehicle (for example for automatic road recognition or collision warning), a system for side monitoring (for example, likewise for collision warning) or, as the case may be, a parking assisting system.

In the above described example the images provided by the camera 4 are transformed to planar coordinates, as shown in FIG. 3, that is, in the form to which the human eye is accustomed. In the case that the images are needed only for the device 8 for seat occupancy recognition or for any other particular electronic evaluation device, the images provided by the camera 4 can be transformed also to cylindrical coordinates, in which the electronic evaluation is likewise easily possible.

In a particularly preferred manner, the inventive process is suitable for applications, in particular in motor vehicles, in connection with a device for theft protection and an alarm system or a device for transmission of image data. Thereby it is conceivable to transmit the image data via a mobile radio device (mobile telephone or WAP-internet-telephone) to persons, for example, the owners of the motor vehicle.

1. Process for optical monitoring of the internal space of a vehicle, thereby characterized, that
the vehicle internal space is monitored by means of at least one panorama camera (2; 4), which supplies images with curvilinear coordinates,
the images obtained from the panorama camera (2; 4) are transformed to cylindrical or planar coordinates (6), and
the transformed images are subjected to an electronic image evaluation (8).

2. Process according to claim 1, thereby characterized, that the images obtained by the panorama camera (2; 4) are transformed via at least one transformation table to cylindrical or planar coordinates.

3. Process according to claim 1 or 2, thereby characterized, that the electronic image evaluation (8) is adapted for recognition of objects.

4. Process according to claim 3, thereby characterized, that the objects to be recognized include persons in the vehicle internal space.

5. Process according to claim 4, thereby characterized, that the presence of persons in individual vehicle seats is recognized.

6. Process according to claim 4, thereby characterized, that the postures of persons in the vehicle are recognized.

7. Process according to claim 3, thereby characterized, that the objects to be recognized include items in the vehicle internal space.

8. Process according to one of claim 3 through 7, thereby characterized, that the objects to be recognized additionally include persons and/or objects in the vehicle external space visible through the windows of the vehicle.

9. Process according to one of the preceding claims, thereby characterized, that at least one of the transformed images or information extracted from the processed image signal is stored and/or transmitted by radio to a emergency aid station in the case of a vehicle accident.

10. Vehicle with at least one camera in the vehicle internal space, thereby characterized, that the camera is at least a panorama camera (2; 4), wherein the field of view includes at least the greater portion of a hemisphere, which includes a part of the vehicle internal space as well as a part of the vehicle external space.

11. Vehicle according to claim 10, thereby characterized, that the panorama camera comprises a conventional digital camera (4) and a convex mirror (2) which is located in the field of view of the digital camera.

12. Vehicle according to claim 11, thereby characterized, that the convex mirror (2) is provided in the vicinity of the vehicle ceiling or in the dashboard.

13. Vehicle according to claim 10, thereby characterized, that a mirror (21) is provided in the field of view of the camera (4) and that close to the camera at least one concave mirror (22) is provided, wherein camera (4) and the mirrors (21 and 22) are so positioned and arranged, that the camera (4) can monitor the environment by deflection at the mirrors (21 and 22).

14. Vehicle according to one of claims 11 through 13, thereby characterized, that a device (6) for transformation of the images obtained by the panorama camera (2; 4) to cylindrical or planar coordinates is provided.

15. Vehicle according to claim 14, thereby characterized, that in addition a device (8) for electronic evaluation of the transformed images is provided.

16. Use of the vehicle according to one of claims 1 through 9 for an application in connection with a device for theft protection, an alarm or a device for transmission of image data.
